(19) United States
(12) Patent Application Publication
(10) Pub. No.: US 2003/0235141 A1
(43) Pub. Date: Dec. 25, 2003

(54) Clearance adjusting screw and beam angle adjusting mechanism

(76) Inventor: Naohide Ohta, Nagano (JP)

Correspondence Address: BIRCH STEWART KOLASCH & BIRCH, PO BOX 747, FALLS CHURCH, VA, 22040-0747, US

(21) Appl. No.: 10/237,055

(22) Filed: Sep. 9, 2002

(30) Foreign Application Priority Data
Jun. 19, 2002 (JP) 2002-178818

(51) Int. Cl. G11B 17/00; G11B 21/16; G11B 23/00; G11B 25/00

(52) U.S. Cl. 369/244; 369/263

(57) ABSTRACT

The clearance adjusting screw is capable of precisely adjusting a clearance between a first body and a second body. In the clearance adjusting screw, a first male screw section is capable of screwing with a first female screw section of the first body. A second male screw section is capable of screwing with a second female screw section of the second body. The first male screw section and the second male screw section are coaxially formed, and one of the male screw sections is a right-hand screw, and the other male screw section is a left-hand screw.

### BACKGROUND OF THE INVENTION

The present invention relates to a clearance adjusting screw for adjusting a clearance between two bodies and a beam angle adjusting mechanism of a disk player, which writes data on an optical disk, e.g., CDs, employing the clearance adjusting screw so as to precisely adjust an angle of a laser beam irradiated from an optical pick-up.

These days, data are written on and stored in optical disks, e.g., CD-Rs, CD-RWs, DVDs. And, disk players capable of writing and reproducing data, e.g., CD-RW players, DVD players, are manufactured. To write data on an optical disk, a power of a laser beam irradiating the optical disk must be maintained prescribed level. Thus, a high power optical pick-up is employed, further it is important to irradiate the laser beam at the right angle with respect to the optical disk.

However, degree of parallel between a turn table, on which the optical disk is mounted, and a chassis, to which the optical pick-up is slidably attached, is not fixed due to machining accuracy of parts, assembling accuracy, etc. Namely, the degree of parallel of disk players usually vary.

To precisely adjust the degree of parallel between the turn table and the chassis, some beam angle adjusting mechanisms for adjusting an angle of a laser beam irradiated from the optical pick-up have been employed in disk players. By the mechanisms, the degree of parallel between the turn table and the chassis or a beam angle of the laser beam with respect to the optical disk can be adjusted when disk players are shipped.

An example of the conventional beam angle adjusting mechanisms is shown in FIGS. 1, 2 and 9. FIG. 1 is a plan view of a chassis of a generic disk player. FIG. 1 shows a relationship between an optical pick-up attached to a chassis and a turn table, and positions of three connecting points of the beam angle adjusting mechanism. FIG. 2 is a sectional view taken along a line X-X of FIG. 1. FIG. 9 is a sectional view of the conventional beam angle adjusting mechanism taken along a line Y-Y of FIG. 1.

As shown in FIG. 1, a chassis 10 is formed like a plate and fixed in a housing (not shown) of a disk player. A guide rail (not shown) is fixed on the chassis 10m and an optical pick-up 12 is moved along the guide rail, so that the optical pick-up 12 can be moved in the radial direction of an optical disk 14. The guide rail is usually arranged in parallel to the chassis 10. Therefore, the optical pick-up 12 is moved in a plane parallel to the chassis 10.

As shown in FIG. 2, a turn table 18 is fixed to an output shaft 16 of a spindle motor 20. The spindle motor 20 is fixed to a motor plate 22, and the motor plate 22 is attached to the chassis 10, so that the spindle motor 20 is attached to the chassis 10.

An angle of the motor plate 22 with respect to the chassis 10 can be adjusted by an adjusting mechanism 24. By adjusting the angle of the motor plate 22, an angle between the turn table 18 and the chassis 10 can be adjusted, so that a beam angle of a laser beam irradiated from the optical pick-up 12, with respect to the optical disk 14, can be adjusted.

The mechanism 24 for adjusting the angle of the turn table 18 will be explained with reference to FIG. 9. The mechanism 24 is provided between the motor plate 22 and the chassis 10. The motor plate 22 and the chassis 10 are mutually connected at three connecting points 26, 28 and 30.

The point 26 acts as a standard connecting point. At the standard connecting point 26, a clearance between the chassis 10 and the motor plate 22 is fixed, namely the clearance cannot be changed. Other points 28 and 30 act as adjustable connecting points, at which the clearance can be adjusted. By the adjustable connecting points 28 and 30, the clearance between the motor plate 22 and the chassis 10 at the standard connecting point 26 can be maintained, even if the angle of the motor plate 22 is slightly changed.

For example, a stud 32 is provided between the chassis 10 and the motor plate 22 at the standard connecting point 26 (see FIG. 9). The stud 32 is fixed by a screw 34, which is inserted from the motor plate 22 side. Further, a ring-shaped elastic member 40 is provided between the stud 32 and the motor plate 22 as a shock absorber.

The clearance between the chassis 10 and the motor plate 22 can be adjusted at the adjustable connecting points 28 and 30. Note that, the point 30 may be the standard connecting point; the points 26 and 30 may be the adjustable connecting points.

At the adjustable connecting points 28 and 30, screws 104 are respectively pierced through through-holes 100 bored in the motor plate 22, and their front end sections are respectively screwed with female screw sections 102 of the chassis 10. Coil springs 106, which respectively cover the screws 104, are elastically provided between the chassis 10 and the motor plate 22. With this structure, the coil springs 106 always bias the motor plate 22 to move away from the chassis 10, so that the motor plate 22 contacts flat faces of head sections 104a of the screws 104.

When a worker turns the screws 104 so as to move the motor 22 toward the chassis 10, the head sections 104a push the motor plate 22, so that the clearance between the chassis 10 and the motor plate 22 is made narrower. On the other hand, when the worker turns the screws 104 in the opposite direction, the head sections 104a are moved away from the chassis 10, so that the motor plate 22 is moved away from the chassis 10, together with the head sections 104a, by the coil springs 106.

By adjusting the clearance between chassis 10 and the motor plate 22 by turning the screw or screws 104 at the adjustable connecting point or points 28 and 30, the angle of the motor plate 22 with respect to the chassis 10 can be adjusted. Further, inclination of the turn table 18, which is fixed to the output shaft 16 of the spindle motor 20, can be adjusted.

However, the coil springs 106 of the adjustable connecting points 28 and 30 can absorb shocks and vibrations applied to the disk player, but the coil springs 106 vary the clearance between the chassis 10 and the motor plate 22. By the expansion and contraction of the coil springs 106, it is difficult to maintain the beam angle of the laser beam with respect to the optical disk 14.

When the disk player is shocked, a part of the coil spring 106 is accidentally engaged with a thread of a male screw section of the screw 104. If the coil spring 106 is engaged, the coil spring 106 cannot return to an initial position and the motor plate 22 is much inclined with respect to the chassis 10.

Further, in the case of rotating the optical disk 104 at high speed, the disk player vibrates. The vibration badly influences the coil springs 106, so that the clearance between the chassis 10 and the motor plate 22 vary. By the variation of the clearance, the beam angle of the laser beam cannot be steadied.

### SUMMARY OF THE INVENTION

An object of the present invention is to provide a clearance adjusting screw, which is capable of precisely adjusting a clearance between two bodies, and a beam angle adjusting mechanism of a disk player, which is capable of precisely adjusting an angle of a laser beam with respect to an optical disk.

To achieve the object, the clearance adjusting screw, which is capable of adjusting a clearance between a first body and a second body,

comprises:

a first male screw section capable of screwing with a first female screw section of the first body; and

a second male screw section capable of screwing with a second female screw section of the second body,

wherein the first male screw section and the second male screw section are coaxially formed, and

one of the male screw sections is a right-hand screw, and the other male screw section is a left-hand screw.

In the clearance adjusting screw, a diameter of the second male screw section may be shorter than that of the first male screw section,

the second male screw section may be extended from one end of the first male screw section, and

a head section, which contacts the first body, may be provided to the other end of the first male screw section. With this structure, the clearance between the two bodies can be adjusted by inserting the clearance adjusting screw from outside of the first body.

The beam angle adjusting mechanism, which is capable of adjusting an angle of a laser beam irradiated from an optical pick-up of a disk player,

comprises:

a chassis holding the optical pick-up;

a plate holding a spindle motor, in which a turn table for holding an optical disk is attached to an output shaft;

a standard connecting point at which the chassis and the plate are connected and a clearance therebetween is fixed;

at least one adjustable connecting point at which the chassis and the plate are connected and the clearance therebetween can be adjusted; and

a clearance adjusting screw for adjusting the clearance between the chassis and the plate at the adjustable connecting point so as to adjust an angle of the plate with respect to the chassis,

wherein the clearance adjusting screw comprises:

a first male screw section is capable of screwing with a first female screw section of the plate,

a second male screw section is capable of screwing with a second female screw section of the chassis,

the first male screw section and the second male screw section are coaxially formed, and

one of the male screw sections is a right-hand screw, and the other male screw section is a left-hand screw.

Further, the beam angle adjusting mechanism,

comprises:

a plate holding the optical pick-up;

a chassis holding a spindle motor, in which a turn table for holding an optical disk is attached to an output shaft;

a standard connecting point at which the chassis and the plate are connected and a clearance therebetween is fixed;

at least one adjustable connecting point at which the chassis and the plate are connected and the clearance therebetween can be adjusted; and

a clearance adjusting screw for adjusting the clearance between the chassis and the plate at the adjustable connecting point so as to adjust an angle of the plate with respect to the chassis,

wherein the clearance adjusting screw comprises:

a first male screw section is capable of screwing with a first female screw section of the plate,

a second male screw section is capable of screwing with a second female screw section of the chassis,

the first male screw section and the second male screw section are coaxially formed, and

one of the male screw sections is a right-hand screw, and the other male screw section is a left-hand screw.

In the mechanism, a diameter of the second male screw section of the clearance adjusting screw may be shorter than that of the first male screw section,

the second male screw section may be extended from one end of the first male screw section, and

a head section, which contacts the plate, may be provided to the other end of the first male screw section.

### BRIEF DESCRIPTION OF THE DRAWINGS

Embodiments of the present invention will now be described by way of examples and with reference to the accompanying drawings, in which:

FIG. 1 is a plan view of a chassis of a generic disk player including an optical pick-up, a turn table and three connecting points;

FIG. 2 is a sectional view taken along a line X-X in FIG. 1;

FIG. 3 is a sectional view of a beam angle adjusting mechanism of a first embodiment of the present invention taken along a line Y-Y in FIG. 1;

FIGS. 4A-4C are explanation views of a clearance adjusting screw;

FIGS. 5A and 5B are explanation views of another clearance adjusting screw;

FIGS. 6A-6C are explanation views of examples of standard connecting points;

FIG. 7 is a plan view of the beam angle adjusting mechanism of a second embodiment;

FIG. 8 is a front view of the beam adjusting mechanism seen from a direction of an arrow in FIG. 7; and

FIG. 9 is a sectional view of the conventional beam angle adjusting mechanism taken along the line Y-Y in FIG. 1.

### DETAILED DESCRIPTION OF THE EMBODIMENTS

Preferred embodiments of the present invention will now be described in detail with reference to the accompanying drawings. In the embodiments, beam angle adjusting mechanisms including clearance adjusting screws will be explained. Note that, the elements described in BACKGROUND OF THE INVENTION are assigned the same symbols and explanation will be omitted.

### First Embodiment

In the first embodiment, the beam angle adjusting mechanism adjusts inclination of a spindle motor 20, to which the turn table 18 is attached, with respect to the chassis (a second body) 10, so that an angle of a laser beam irradiated from the optical pick-up 12, with respect to the optical disk 14, can be adjusted.

Firstly, the structure of the beam angle adjusting mechanism will be explained. The basic structure of the beam angle adjusting mechanism 24 of the present embodiment is almost equal to that of the conventional mechanism. Namely, the turn table 18 is fixed to the output shaft of the spindle motor 20; the spindle motor 20 is fixed to the motor plate (a first body) 22; and the motor plate 22 is connected to the chassis 10 at three connecting points 26, 28 and 30.

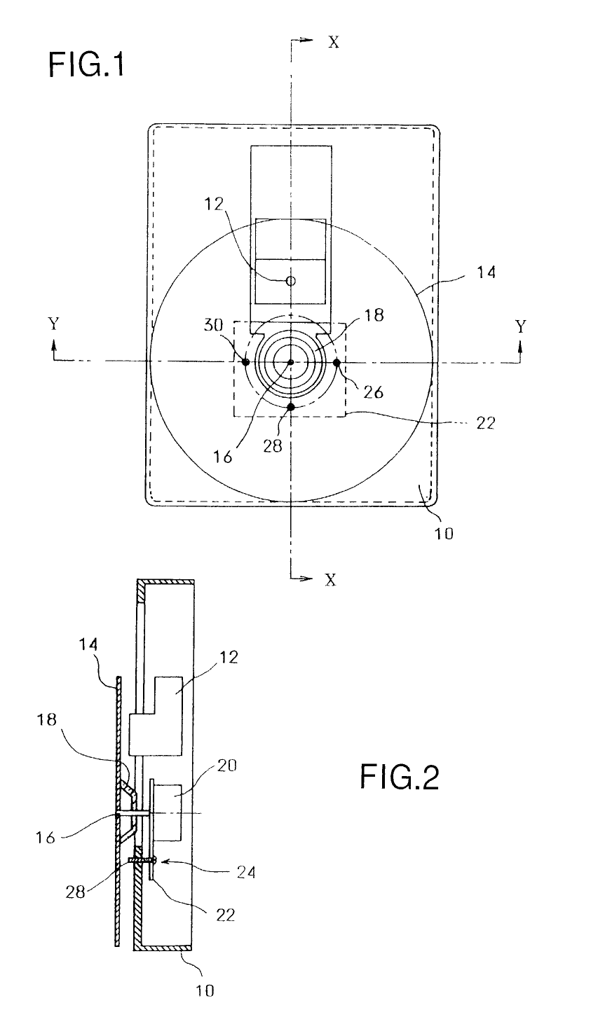

As shown in FIG. 1, the connecting points 26, 28 and 30 are provided on a circumference, which is coaxial with the output shaft 16, with angular separation of 90°. The arrangement and number of the connecting points 26, 28 and 30 is not limited to the present example. But the connecting points must not be arranged linearly.

In the present embodiment, the connecting point 26 is the standard connecting point; the connecting points 28 and 30 are the adjustable connecting points. By adjusting inclination of the motor plate 22 at the connecting point or points 28 and 30, the inclination of the turn table 18 with respect to the chassis 10 can be optionally adjusted.

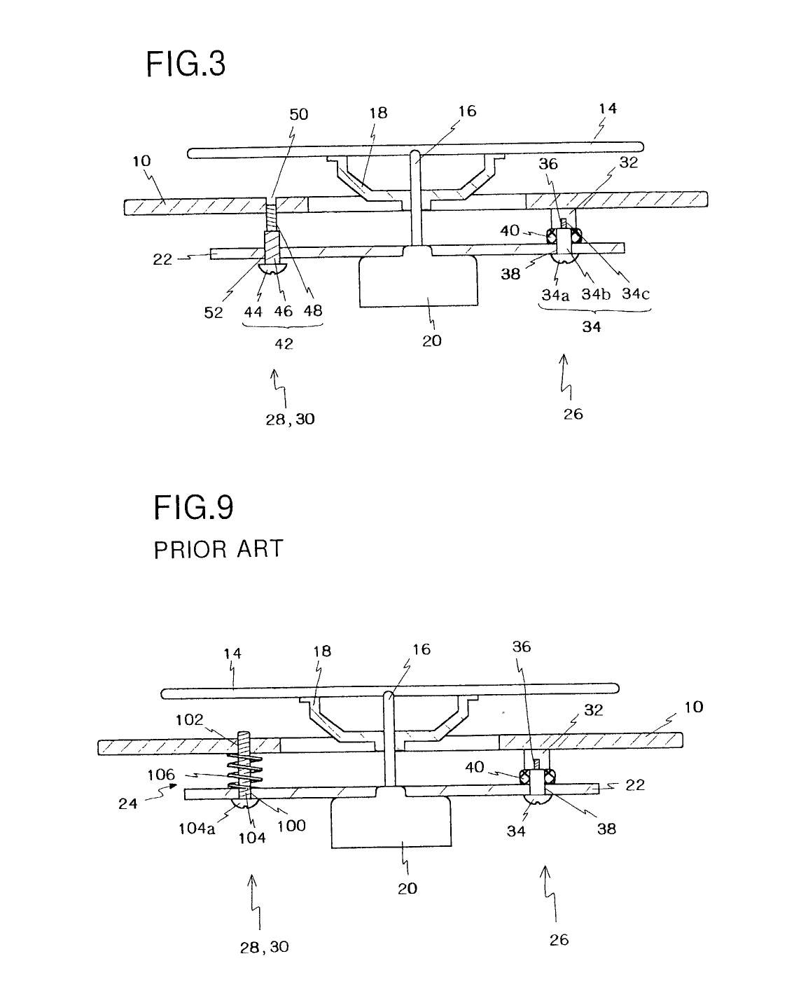

FIG. 3 is the sectional view of the beam angle adjusting mechanism of the present embodiment taken along a line Y-Y in FIG. 1.

As shown in FIG. 3, at the standard connecting point 26, the stud 32 is provided between the chassis 10 and the motor plate 22. The stud 32 is fixed by the screw, which is inserted from the motor plate 22 side, so that a clearance between the chassis 10 and the motor plate 22 can be fixed at the standard connecting point 26.

The stud 32 is formed into a columnar shape. One end face of the stud 32 is fixed to a lower face of the chassis 10; a female screw section 36 is formed in the other end face thereof. The screw 34, which is pierced through a through-hole 38 of the motor plate 22, is screwed with the female screw section 36, so that the stud 32 is fixed and the clearance between the chassis 10 and the motor plate 22 can be fixed or maintained at the standard connecting point 26.

The screw 34 includes a head section 34a, a large diameter section 34b and a small diameter section 34c. A flat face of the head section 34a contacts a lower face of the motor plate 22, and the large diameter section 34b is pierced through the through-hole 38 of the motor plate 22. A diameter of the small diameter section 34c is shorter than that of the large diameter section 34b. The large diameter section 34b and the small diameter section 34c are coaxially arranged. A male screw, which can be screwed with the female screw section 36 of the stud 32, is formed on an outer circumferential face of the small diameter section 34c.

The ring-shaped elastic member 40, which is made of an elastic material, e.g., butyl rubber, is provided between the lower face of the stud 32 and an upper face of the motor plate 22 as a shock absorber. Shock and vibration can be absorbed by the elastic member 40, so that load applied to the standard connecting point 26 can be reduced.

Next, the adjustable connecting points 28 and 30 will be explained. In the present embodiment, clearance adjusting screws 42 are provided to the adjustable connecting points 28 and 30 (see FIG. 3).

The clearance adjusting screw 42 has a head section 44, a large diameter section 46 and a small diameter section 48. In the present embodiment, the large diameter section 46 acts as a first male screw section; the small diameter section 48 acts as a second male screw section. The head section 44 is turned, by a tool, e.g., a screw driver. The large diameter section 46 is extended from the head section 44, and the small diameter section 48 is coaxially extended from the large diameter section 46. A diameter of the large diameter section 46 is greater than that of the small diameter section 48. A thread 47 is formed on an outer circumferential face of the large diameter section 46; a thread 49 is formed on an outer circumferential face of the small diameter section 48. In the present embodiment, the thread 47 of the large diameter section 46 is formed as a right-hand screw; the thread 49 of the small diameter section 48 is formed as a left-hand screw.

Note that, in the case that a viewer sees the right-hand screw from one end and a point on the large diameter section 46 is moved along the thread 47 in the clockwise direction, the point is moved away from the viewer; in the case that the viewer sees the left-hand screw from one end and a point on the small diameter section 48 is moved along the thread 49 in the counterclockwise direction, the point is moved away from the viewer.

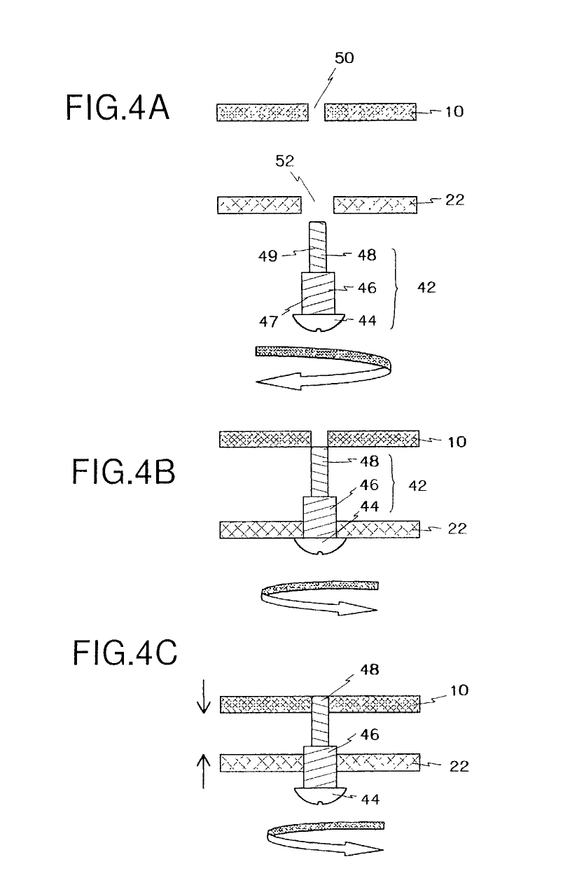

Function of the clearance adjusting screw 42 at the adjustable connecting point will be explained with reference to FIGS. 4A-4C.

As shown in FIG. 4A, the chassis 10 has a female screw section 50, which can be screwed with the thread 49 of the small diameter section 48 of the clearance adjusting screw 42; the motor plate 22 has a female screw section 52, which can be screwed with the thread 47 of the large diameter section 46. Namely, the female screw section 52 acts as a first female screw section; the female screw section 50 acts as a second female screw section.

By inserting the clearance adjusting screw 42 into the female screw section 52 from the lower side of the motor plate 22 with turning the screw 42 in the clockwise direction, the large diameter section 46 of the screw 42 is screwed with the female screw section 52. The large diameter section 46 is screwed until a flat face of the head section 44 of the screw 42 contacts the lower face of the motor plate 22. Since the small diameter section 48 of the screw 42 is the left-hand screw, the small diameter section 48 is not screwed with and inserted into the female screw section 50 of the chassis 10. This state is shown in FIG. 4B.

Then, the clearance adjusting screw 42 is turned in the counterclockwise direction so as to screw the small diameter section 48 with the female screw section 50 of the chassis 10. By screwing the small diameter section 48 with the female screw section 50, the chassis 10 is moved toward the large diameter section 46 as shown in FIG. 4C. On the other hand, the motor plate 22 is moved away from the head section 44 toward the small diameter section 48.

By turning the clearance adjusting screw 42 in the counterclockwise direction, the chassis 10 and the motor plate 22 are gradually moved close to each other. Therefore, the clearance between the chassis 10 and the motor plate 22 can be precisely adjusted. Note that, the standard connecting point 26 acts as a fulcrum point while adjusting the clearance.

The screw 42 can be easily inserted from outside. Since the chassis 10 and the motor plate 22 are screwed with the clearance adjusting screw 42, they are not influenced by shock and vibration. Thus, the clearance between the chassis 10 and the motor plate 22 can be maintained stably. Unlike the conventional beam angle adjusting mechanism, no coil springs are used in the present embodiment, so the structure can be simplified and number of parts can be reduced.

In the present embodiment, the large diameter section 46 of the adjusting screw 42 is the right-hand screw and the small diameter section 48 is the left-hand screw. The present invention is not limited to the embodiment, so the large diameter section 46 may be the left-hand screw and the small diameter section 48 may be the right-hand screw. Further, the head section 44 is not limited. For example, a head section turned by a wrench may be employed as the head section 44.

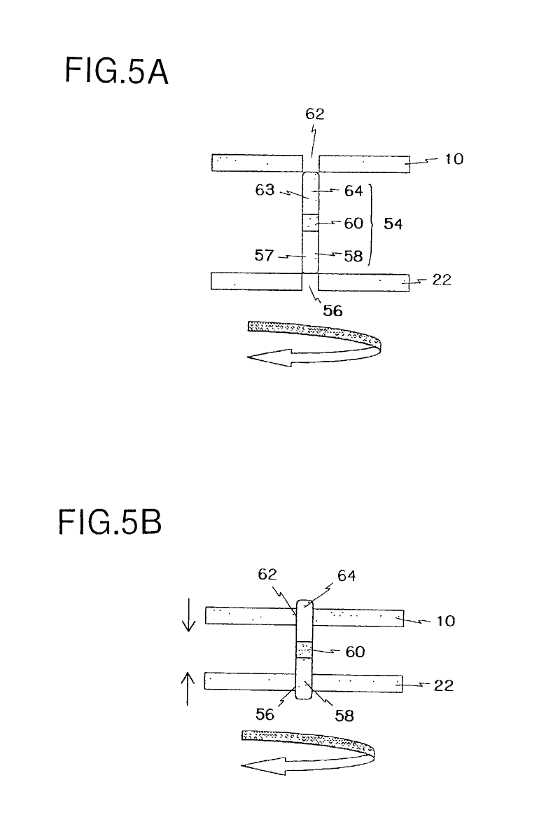

Another clearance adjusting screw is shown in FIGS. 5A and 5B. The clearance adjusting screw 54 has no head section, and diameter of a first male screw section 58, an intermediate section 60 and a second male screw section 64 are same.

The first male screw section 58 has a thread 57, which can be screwed with a female screw section (the first female screw section) 56 of the motor plate 22. The second male screw section 64 has a thread 63, which can be screwed with a female screw section (the second female screw section) 62 of the chassis 10. The intermediate section 60 is formed between the first male screw section 58 and the second male screw section 64. In this example, the thread 57 of the first male screw section 58 is formed as the left-hand screw; the thread 63 of the second male screw section 64 is formed as the right-hand screw.

As shown in FIG. 5A, the clearance adjusting screw 54 is provided between the chassis 10 and the motor plate 22. By turning the screw 54 in the clockwise direction, the first male screw section 58 and the second male screw section 64 are simultaneously respectively screwed with the female screw sections 56 of the motor plate 22 and the female screw sections 62 of the chassis 10.

Since the first male screw section 58 is the left-hand screw and the second male screw section 64 is the right-hand screw, the both screw sections 58 and 64 can be simultaneously screwed by turning the screw in the clockwise direction.

With this action, the motor plate 22 is moved toward the chassis 10 as shown in FIG. 5B. Namely, the chassis 10 and the motor plate 22 can be gradually moved close to each other by turning the clearance adjusting screw 54. Thus, the clearance between the chassis 10 and the motor plate 22 can be precisely adjusted. Since the chassis 10 and the motor plate 22 are screwed with the clearance adjusting screw 54, the clearance between the chassis 10 and the motor plate 22 can be maintained stably.

Note that, means for turning the screw 54 is not limited. For example, a recess for engaging with a wrench may be formed at a lower end of the first male screw section 58. In this case, the screw 54 can be easily turned by the wrench.

The intermediate section 60 is formed between the first male screw section 58 and the second male screw section 64, and has no screw thread. The intermediate section 60 is not an essential element. For example, the second male screw section 64 may be extended from the first male screw section 58 without forming the intermediate section.

In the example shown in FIGS. 5A and 5B, the first male screw section 58 is the left-hand screw; the second male screw section 64 is the right-hand screw. But the present invention is not limited. The first male screw section 58 may be the right-hand screw; the second male screw section 64 may be the left-hand screw.

In the present invention, angle of the threads of the male screw sections are optionally designed. For example, the angle of the first male screw section and the second male screw section may be equal or different.

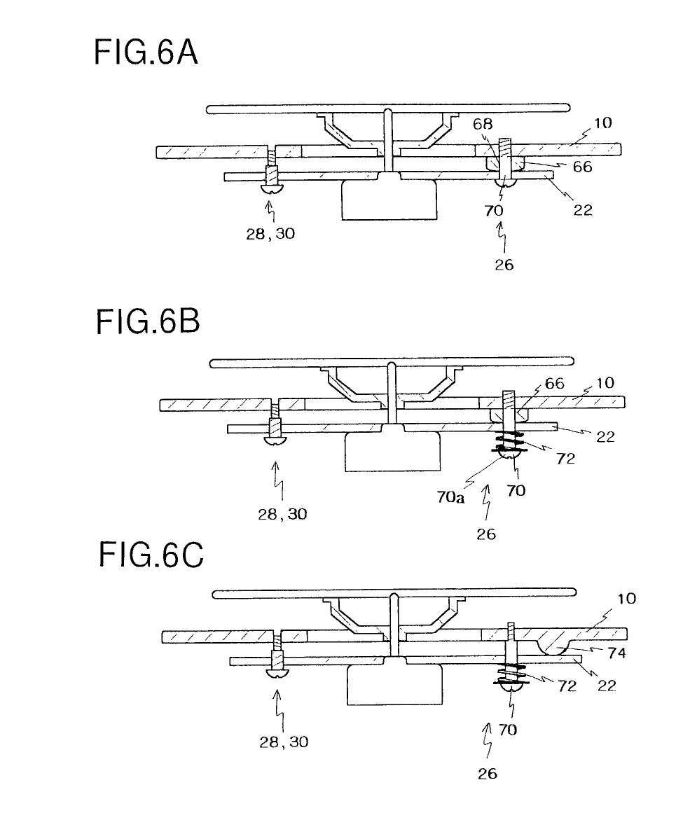

The structure of the standard connecting point is not limited to the example shown in FIG. 3. Other examples are shown in FIGS. 6A-6C.

In FIG. 6A, a spacer 66 is provided between the chassis 10 and the motor plate 22. The spacer 66 is fixed on the lower face of the chassis 10, and a lower curved face of the spacer 66 contacts the upper face of the motor plate 22. A screw 70 is inserted into a through-hole 68 of the spacer 66 from the motor plate 22 side and screwed with the chassis 10. With this structure, the spacer 66 is fixed, and the clearance between the chassis 10 and the motor plate 22 can be fixed or maintained.

In FIG. 6B, an elastic member 72, e.g., a coil spring, is elastically provided between the lower face of the motor plate 22 and a flat face of a head section 70a of a screw 70. The elastic member 72 always biases the motor plate 22 toward the chassis 10 and absorbs shock and vibration.

In FIG. 6C, a projection 74 is projected from the chassis 10 toward the motor plate 22 instead of the spacer 66. With this structure, the clearance between the chassis 10 and the motor plate 22 can be fixed or maintained.

### Second Embodiment

In the first embodiment, the motor plate 22 can be inclined with respect to the chassis 10. By adjusting the inclination angle of the motor plate 22, the beam angle of the laser beam, which is irradiated from the optical pick-up 12 to the optical disk 14, can be adjusted.

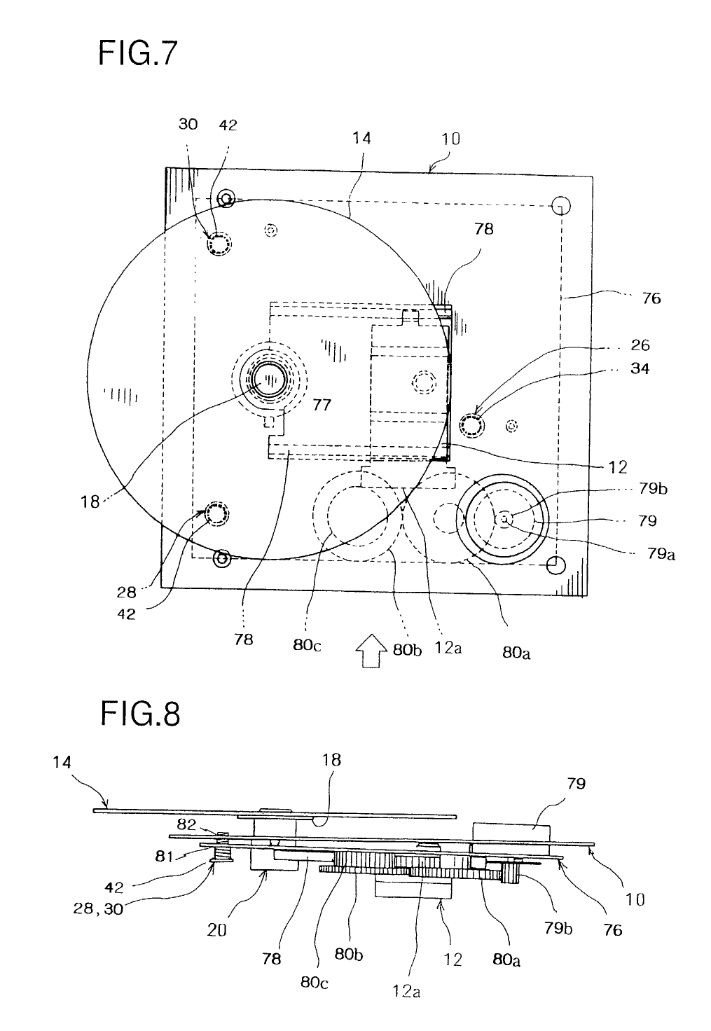

In the second embodiment, the optical pick-up can be inclined with respect to the chassis, and the beam angle will be adjusted by adjusting an inclination angle of the optical pick-up. The second embodiment will be explained with reference to FIGS. 7 and 8. Note that, the elements described in the first embodiments are assigned the same symbols and explanation will be omitted.

The optical pick-up 12, a pair of guide rails 78 for guiding the optical pick-up 12 and a drive unit for moving the optical pick-up along the guide rails 78 are provided to a pick-up plate 76 (the first body).

A rectangular opening section 77 is opened in a center part of the pick-up plate 76. The guide rails 78 are arranged parallel and fixed along edges of the opening section 77. The optical pick-up 12 is slidably attached to the guide rails 78.

The drive unit includes a motor 79. The motor 79 is fixed to the pick-up plate 76, a gear 79b is attached to an output shaft 79a. The optical pick-up 12 has a rack 12a. Reduction gears 80a, 80b and 80c are rotatably provided to the pick-up plate 76. The gear 79b is engaged with the reduction gear 80a, and the rack 12a is engaged with the reduction gear 80c. With this structure, torque of the motor 79 can be transmitted to the optical pick-up 12, and the optical pick-up 12 can be linearly moved.

The pick-up plate 76, which holds the optical pick-up 12, is connected to the chassis 10 at one standard connecting point 26 and two adjustable connecting points 28 and 30 as well as the first embodiment. With this structure, the pick-up plate 22 can be inclined with respect to the chassis 10.

The stud 32, the screw 34 having the large diameter section and the small diameter section, and the elastic member 40 (see FIG. 3) are provided to the standard connecting point 26 so as to fix or maintain a clearance between the chassis 10 and the optical pick-up 76 as well as the first embodiment.

The clearance adjusting screws 42, each of which has the head section 44, the large diameter section 46 and the small diameter section 48, are provided to the adjustable connecting points 28 and 30 as well as the first embodiment. The large diameter sections 46 of the screws 42 are respectively screwed with female screw sections (first female screw sections) 81 of the pick-up plate 76; the small diameter sections 48 of the screws 42 are respectively screwed with female screw sections (second female screw sections) 82 of the chassis 10. With this structure, the clearance between the chassis 10 and the pick-up plate 76 can be adjusted at the adjustable connecting points 28 and 30. Since the clearance adjusting screws 42 are screwed with the chassis 10 and the pick-up plate 76, the clearance can be stably maintained. Unlike the conventional beam angle adjusting mechanism, no coil springs are used in the present embodiment, so the structure can be simplified and number of parts can be reduced.

In the present embodiment too, the arrangement and the number of the connecting points is not limited to three. The standard connecting points 26 shown in FIGS. 6A-6C may be employed in the second embodiment. Further, the clearance adjusting screws 54 shown in FIGS. 5A and 5B may be provided to the adjustable connecting points 28 and 30 of the second embodiment.

When the beam angle of the laser beam irradiated from the optical pick-up 12 to the disk 14 is adjusted, the clearance adjusting screws 42 or 54 is turned to vary the clearance between the chassis 10 and the pick-up plate 76 at the points 28 and 30. With this action, the pick-up plate 76 can be inclined with respect to the chassis 10. At that time, the standard connecting point 26 acts as a fulcrum point. Therefore, the optical pick-up 12 which is attached to the pick-up plate 76 can be inclined with respect to the chassis 10 and the turn table 18 fixed to the output shaft of the spindle motor 20, so that the beam angle of the laser beam with respect to the optical disk 14 can be adjusted.

In the above described embodiments, the clearance adjusting screws 42 and 54 are employed in the beam angle adjusting mechanism of the disk player. The clearance adjusting screw of the present invention, of course, may be used for other purposes.

The invention may be embodied in other specific forms without departing from the spirit or essential characteristics thereof. The present embodiments are therefore to be considered in all respects as illustrative and not restrictive, the scope of the invention being indicated by the appended claims rather than by he foregoing description and all changes which come within the meaning and range of equivalency of the claims are therefore intended to be embraced therein.

What is claimed is:

1. A clearance adjusting screw for adjusting a clearance between a first body and a second body,
comprising:
a first male screw section capable of screwing with a first female screw section of the first body; and
a second male screw section capable of screwing with a second female screw section of the second body,
wherein said first male screw section and said second male screw section are coaxially formed, and
one of said male screw sections is a right-hand screw, and the other male screw section is a left-hand screw.

2. The clearance adjusting screw according to claim 1,
wherein a diameter of said second male screw section is shorter than that of said first male screw section,
said second male screw section is extended from one end of said first male screw section, and
a head section, which contacts the first body, is provided to the other end of said first male screw section.

3. A beam angle adjusting mechanism for adjusting an angle of a laser beam irradiated from an optical pick-up of a disk player,
comprising:
a chassis holding the optical pick-up;
a plate holding a spindle motor, in which a turn table for holding an optical disk is attached to an output shaft;
a standard connecting point at which said chassis and said plate are connected and a clearance therebetween is fixed;
at least one adjustable connecting point at which said chassis and said plate are connected and the clearance therebetween can be adjusted; and
a clearance adjusting screw for adjusting the clearance between said chassis and said plate at said adjustable connecting point so as to adjust an angle of said plate with respect to said chassis,
wherein said clearance adjusting screw comprises:
a first male screw section is capable of screwing with a first female screw section of said plate,
a second male screw section is capable of screwing with a second female screw section of said chassis,
said first male screw section and said second male screw section are coaxially formed, and
one of said male screw sections is a right-hand screw, and the other male screw section is a left-hand screw.

4. The mechanism according to claim 3,
wherein a diameter of said second male screw section of said clearance adjusting screw is shorter than that of said first male screw section,
said second male screw section is extended from one end of said first male screw section, and
a head section, which contacts said plate, is provided to the other end of said first male screw section.

5. A beam angle adjusting mechanism for adjusting an angle of a laser beam irradiated from an optical pick-up of a disk player,
comprising:
a plate holding the optical pick-up;
a chassis holding a spindle motor, in which a turn table for holding an optical disk is attached to an output shaft;
a standard connecting point at which said chassis and said plate are connected and a clearance therebetween is fixed;
at least one adjustable connecting point at which said chassis and said plate are connected and the clearance therebetween can be adjusted; and
a clearance adjusting screw for adjusting the clearance between said chassis and said plate at said adjustable connecting point so as to adjust an angle of said plate with respect to said chassis,
wherein said clearance adjusting screw comprises:
a first male screw section is capable of screwing with a first female screw section of said plate,
a second male screw section is capable of screwing with a second female screw section of said chassis,
said first male screw section and said second male screw section are coaxially formed, and
one of said male screw sections is a right-hand screw, and the other male screw section is a left-hand screw.

6. The mechanism according to claim 5,
wherein a diameter of said second male screw section of said clearance adjusting screw is shorter than that of said first male screw section,
said second male screw section is extended from one end of said first male screw section, and
a head section, which contacts said plate, is provided to the other end of said first male screw section.
